(19) United States
(12) Patent Application Publication
(10) Pub. No.: US 2012/0075088 A1
(43) Pub. Date: Mar. 29, 2012

(54) SAFE DISTANCE MEASURING DEVICE FOR A VEHICLE

(75) Inventor: Jim Ray Marentes Aguilar, Albuquerque, NM (US)

(73) Assignee: Mesa Digital, LLC.

(21) Appl. No.: 13/103,218

(22) Filed: May 9, 2011

Related U.S. Application Data
(60) Provisional application No. 61/387,637, filed on Sep. 29, 2010.

(51) Int. Cl. B60Q 1/00

(52) U.S. Cl. 340/435

(57) ABSTRACT

A safe distance measuring device, methods, and processor-readable medium for measuring and displaying a safe distance between vehicle and surrounding traffic. A distance measuring device measures the distances between the vehicle and surrounding traffic. A speed sensor can be utilized for sensing a current speed of the vehicle. A processor calculates the safe distances between the vehicle and surrounding traffic by utilizing the distance measured by the distance measuring device and the current speed of vehicle. A display unit can be utilized for displaying the safe distance between the vehicle and other vehicles. A warning output device can be provided for outputting an alarm to the driver of the vehicle when a vehicle distance is less than the calculated safe distance.

### CROSS-REFERENCE TO PROVISIONAL APPLICATION

This patent application claims the benefit under 35 U.S.C. §119(e) of U.S. Provisional Application Ser. No. 61/387,637 entitled, “Safe Distance Measuring Device for a Vehicle,” which was filed on Sep. 29, 2010 and is incorporated herein by reference in its entirety.

### TECHNICAL FIELD

Embodiments are generally related to safety devices for vehicles. Embodiments also relate to the field of vehicle installed safe distance measuring devices. Embodiments additionally relate to a safe distance measuring device utilized for measuring and displaying a safe distance between a driver and surrounding traffic.

### BACKGROUND OF THE INVENTION

Automobile accidents result in thousands of fatalities and injuries each year, as well as generating millions of dollars in property damage around the world, Rear-end collisions, a type of automobile accident, are common because of a driver following another vehicle too closely. For safety reasons, some modernized motor vehicles are equipped with distance measuring equipment. When a moving vehicle comes very close to a vehicle in front of it, the equipment gives a visual alarm, an audio alarm or the like to the driver letting him/her know that the distance to the vehicle in front is too close. However, due to their inherent constructions, some of them have failed to exhibit a satisfactory performance.

Many automobile rear-end collisions are caused by a failure to maintain a safe distance between moving vehicles. To reduce the risk of these collisions a minimum separation distance should be kept between moving vehicles. A minimum separation standard recommended by the California Department of Motor Vehicles and others is a separation of, for example, three seconds between traveling vehicles. This separation allows sufficient time for perception of a hazard, decision and reaction time, and mechanical braking distance. Unfortunately, many drivers either ignore this rule or are unaware of this rule. In addition, inexperienced drivers may lack the perception needed to calculate a safe separation distance.

A number of different devices have been developed in order to monitor vehicle separation and enhance vehicle safety. For example, a collision avoidance system has been implemented for continuously measuring a vehicle speed and maintaining a safe separation distance between a forward vehicle. When a minimum safe distance is not maintained between the vehicles, the system automatically applies the brakes of the vehicle by switching over at least one of the engine cylinders to a compressor operation. In another similar system, a radar unit is utilized to determine the distance between a forward vehicle and a driver's vehicle. A tachometer measures the speed of a driver's vehicle in which a safe separation distance is calculated from the speed of the driver's vehicle. If this separation distance is not maintained between the driver's vehicle and the forward vehicle, brakes are automatically applied.

In another device, a safe following distance warning system for a vehicle comprising a forward-looking image capturing unit, a speed sensor, a processor, and a warning output device is disclosed. The forward-looking image capturing unit can be utilized for capturing images of the forward vehicle. The forward-looking image capturing unit includes a taking lens, an image sensor disposed behind the taking lens, an image processing unit, and a lens driving unit. The image processing unit calculates an in-focus position of the taking lens. The speed sensor senses a current speed of the vehicle. The processor can be utilized for calculating a following distance from the driver's vehicle to a vehicle directly in front comparing the following distance to an applicable safe distance parameter. The warning output device outputs an alarm to the driver of the vehicle when the following distance is less than the applicable safe distance parameter.

The prior safe distance measuring device does not display the safe distance between the vehicle and surrounding traffic, instead warns the driver if the distance between the vehicle and surrounding traffic is less than the safe distance. Further, displaying a safe distance (by showing numbers) is valuable information to the driver prompting the driver to maintain a safe distance from surrounding traffic. In an effort to address the foregoing difficulties, it is believed that the safe distance measuring device, as discussed herein, can address many of the problems with traditional safe distance measuring devices.

### BRIEF SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for a vehicle safety device, method, and processor-readable medium.

It is another aspect of the disclosed embodiments to provide for a vehicle-installed safe distance measuring device, methods, and processor-readable media thereof.

It is a further aspect of the disclosed embodiments to provide for a safe distance measuring device, method, and processor-readable medium for measuring and displaying a safe distance between a driver in a vehicle and surrounding traffic.

A vehicle mounted safe distance measuring device for measuring and displaying the safe distance between the driver and surrounding traffic is disclosed. A distance measuring device measures distance between the vehicle and surrounding traffic. A speed sensor can be utilized for sensing the current speed of the vehicle. A processor calculates the safe distance between the vehicle and surrounding traffic by utilizing the distance measured by the distance measuring device and the current speed of vehicle. A display unit, for example, is an instrument cluster that can be utilized for displaying the safe distance between the vehicle and the surrounding vehicles. A warning output device can be provided to output a warning signal, for example, an alarm to the driver of the vehicle when the vehicle distance is less than calculated safe distance. A safe distance can be displayed by green numbers and an unsafe distance can be displayed by red numbers, followed by a sound in some instances, if following too close.

The display thus displays the safe distance between the vehicle and surrounding traffic. The driver can safely drive the vehicle while viewing the “safe distance” via the display. There are various factors that affect the calculation of safe distance between the vehicle and surrounding traffic. The processer, for example, may utilize the following factors: load, condition of the road surface, tires, brakes, driver skill, and type of vehicle for calculating the safe distance, along with the distance between the vehicle and surrounding traffic and vehicle speed.

Thus, in one example embodiment, a safe distance measuring apparatus for a vehicle can include at least one distance-measuring device for measuring a plurality of distances from the vehicle to at least one of a plurality of other vehicles, and a speed sensor for sensing a current speed of the vehicle. Such an embodiment can also include a display unit for displaying a plurality of safe distances, and a warning output device for outputting an alarm to a driver of the vehicle when at least one of the plurality of distances is less than the corresponding calculated plurality of safe distances,

In another embodiment, a processor can be employed for calculating the plurality of safe distances from the vehicle to the plurality of vehicles by utilizing the plurality of distances and the current speed. In general, the safe distance measuring device can be installable within the vehicle. In some embodiments, the distance-measuring device can be a LASER type device. In yet other embodiments, the distance-measuring device may be a RADAR type device. In still other embodiments, the distance-measuring device can be an image capturing distance measuring type device or another appropriate device. Additionally, in some embodiments, the display unit displays graphical data indicative of traffic surrounding the vehicle and data indicative of a safe distance between the vehicle and the traffic surrounding the vehicle.

In accordance with another embodiment, a safe distance measuring apparatus for a vehicle can be implemented, which includes at least one distance-measuring device for measuring a plurality of distances from the vehicle to at least one of a plurality of other vehicles; a speed sensor for sensing a current speed of the vehicle; a processor for calculating a plurality of safe distances from the vehicle to the plurality of vehicles by utilizing the plurality of distances and the current speed; a display unit for displaying the plurality of safe distances; and a warning output device for outputting an alarm to a driver of the vehicle when at least one of the plurality of distances is less than the corresponding calculated plurality of safe distances.

In such an embodiment, the safe distance measuring device can be installable within the vehicle. In variations to such an embodiment, the aforementioned distance-measuring device can be, for example, a LASER type device, a RADAR type device, and/or an image capturing distance measuring type device, and so forth. Additionally, in such an embodiment, the display unit can display graphical data indicative of traffic surrounding the vehicle and data indicative of a safe distance between the vehicle and the traffic surrounding the vehicle.

Various methods can be implemented for providing safe distance measurement data for a vehicle. One example of such a method can include the steps of measuring a plurality of distances from the vehicle to at least one of a plurality of other vehicles utilizing at least one-distance-measuring device; sensing a current speed of the vehicle utilizing a speed sensor; automatically calculating a plurality of safe distances from the vehicle to the plurality of vehicles by utilizing the plurality of distances and the current speed; displaying the plurality of safe distances via a display unit; and generating an alarm to a driver of the vehicle when at least one of the plurality of distances is less than the corresponding calculated plurality of safe distances.

In a variation to such an embodiment, the safe distance measuring device can be installable within the vehicle. Additionally, in an alternative embodiment of such a method, the distance-measuring device can be, for example, a LASER type device, a RADAR type device, an image capturing distance measuring type device, and so forth. The display unit in such a method can be configured and instructed to display graphical data indicative of traffic surrounding the vehicle and data indicative of a safe distance between the vehicle and the traffic surrounding the vehicle.

In another embodiment, a processor-readable medium storing code representing instructions to cause a processor to perform a process can be implemented, wherein the code comprises code to, for example, measure a plurality of distances from the vehicle to at least one of a plurality of other vehicles utilizing at least one-distance-measuring device; detect a current speed of the vehicle utilizing a speed sensor; automatically calculate a plurality of safe distances from the vehicle to the plurality of vehicles by utilizing the plurality of distances and the current speed; display the plurality of safe distances via a display unit; and generate an alarm to a driver of the vehicle when at least one of the plurality of distances is less than the corresponding calculated plurality of safe distances.

In alternative embodiment, the processor-readable medium can be configured such that the safe distance measuring device is installable within the vehicle. Additionally, in the context of such a processor-readable medium and variations to embodiments thereof, the distance-measuring device can be, for example, a LASER type device, a RADAR type device, an image capturing distance measuring type device, and so forth. The display unit can receive instructions via the processor-readable radium to display graphical data indicative of traffic surrounding the vehicle and data indicative of a safe distance between the vehicle and the traffic surrounding the vehicle.

### BRIEF DESCRIPTION OF THE DRAWINGS

The accompanying figures, in which like reference numerals refer to identical or functionally-similar elements throughout the separate views and which are incorporated in and form a part of the specification, further illustrate the disclosed embodiments and, together with the detailed description of the invention, serve to explain the principles of the disclosed embodiments.

FIG. 1 illustrates a simplified block diagram of a safe distance measuring device for a vehicle, in accordance with the disclosed embodiments;

FIG. 2 illustrates a perspective view of a vehicle comprising steering, a dashboard, and a display of the safe distance measuring device depicted FIG. 1, in accordance with the disclosed embodiments;

FIG. 3 illustrates a top view of road traffic showing the vehicle installed with the safe distance measuring device of FIG. 1, in accordance with the disclosed embodiments;

FIG. 4 illustrates a perspective view of a display of the safe distance measuring device depicted FIG, 1, in accordance with the disclosed embodiments; and

FIG. 5 illustrates a high level flow chart depicting the process of measuring and displaying a safe distance between vehicle and surrounding traffic, in accordance with disclosed embodiments.

### DETAILED DESCRIPTION

The particular values and configurations discussed in these non-limiting examples can be varied and are cited merely to illustrate at least one embodiment and are not intended to limit the scope thereof.

The embodiments will now be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will be appreciated by one skilled in the art, the present invention can be embodied as a method, data processing system, or computer program product. Accordingly, the present invention may take the form of an entire hardware embodiment, an entire software embodiment, or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized including hard disks, USB Flash Drives, DVDs, CD-ROMs, optical storage devices, magnetic storage devices, etc.

Computer program code for carrying out operations of the present invention may be written in an object oriented programming language (e.g., Java, C++, etc.). The computer program code, however, for carrying out operations of the present invention may also be written in conventional procedural programming languages such as the “C” programming language or in a visually oriented programming environment such as, for example, VisualBasic.

The program code may execute entirely on the user's computer, partly on the user's computer, as a stand-alone software package, partly on the user's computer and partly on a remote computer or entirely on the remote computer. In the latter scenario, the remote computer may be connected to a user's computer through a local area network (LAN) or a wide area network (WAN), wireless data network e.g., WiFi, Wimax, 802.xx, and cellular network or the connection may be made to an external computer via most third party supported networks (for example, through the Internet using an Internet Service Provider).

The invention is described in part below with reference to flowchart illustrations and/or block diagrams of methods, systems, computer program products, and data structures according to embodiments of the invention. It will be understood that each block of the illustrations, and combinations of blocks, can be implemented by computer program instructions. These computer program instructions may be provided to a processor of a general purpose computer, special purpose computer, or other programmable data processing apparatus to produce a machine such that the instructions, which execute via the processor of the computer or other programmable data processing apparatus, create means for implementing the functions/acts specified in the block or blocks.

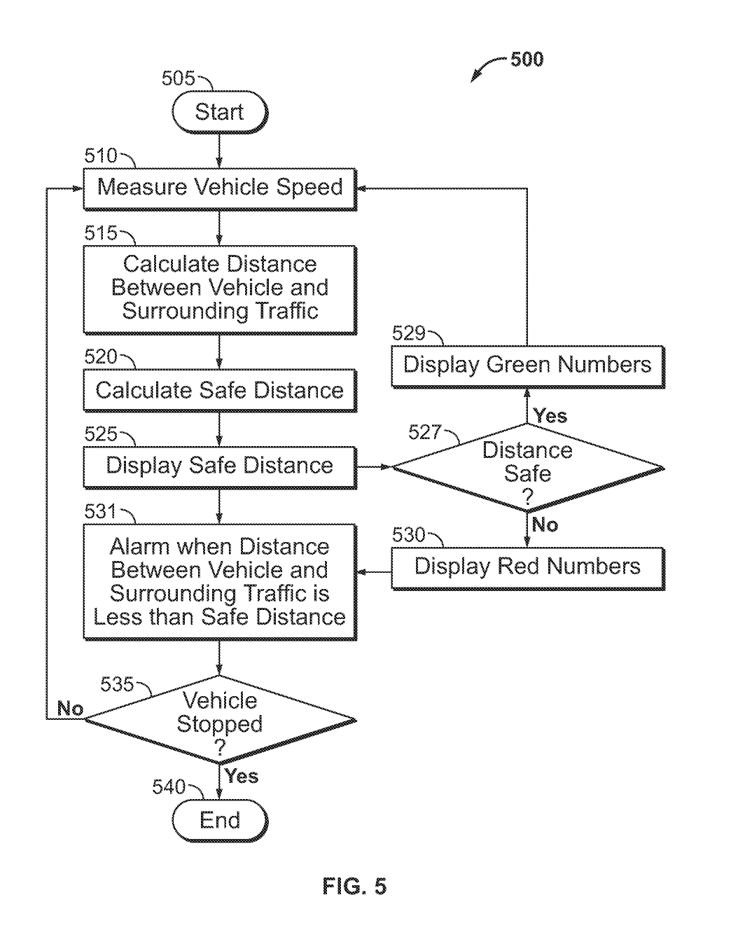

These computer program instructions may also be stored in a computer-readable memory that can direct a computer or other programmable data processing apparatus to function in a particular manner such that the instructions stored in the computer-readable memory produce an article of manufacture including instruction means which implement the function/act specified in the block or blocks. Examples of computer program instructions are, for example, instructions for carrying out the method steps of method 500 depicted in FIG. 5 herein.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

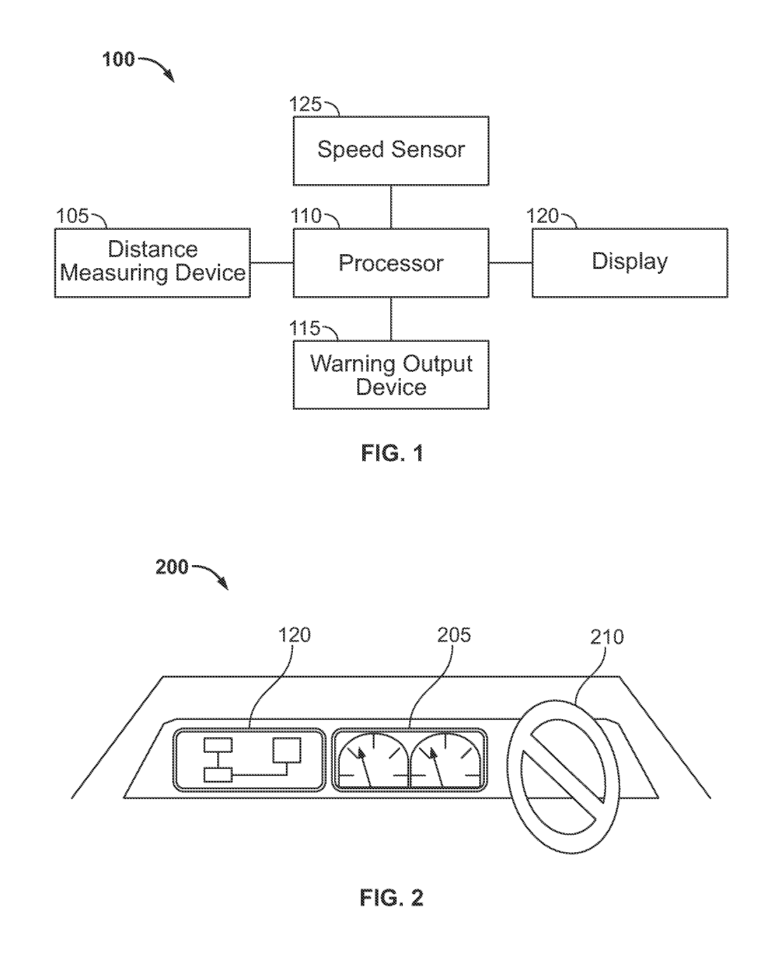

FIG. 1 illustrates a simplified block diagram of a safe distance measuring device 100 for a vehicle, in accordance with the disclosed embodiments. The safe distance measuring device 100 can be installed in the vehicle (not shown) to provide safe distance information between the driver and the surrounding traffic. The safe distance-measuring device 100 can be, for example, a LASER (Light Amplification by Stimulated Emission of Radiation) type, a RADAR (RAdio Detection And Ranging) type, an image capturing distance measuring type device, and so forth,

The distance measuring device 105 measures the distance between the vehicle (not shown) and the surrounding traffic. A speed sensor 125 can be utilized for sensing the current speed of vehicle (not shown). The processor 110 calculates the safe distance between the vehicle (not shown) and surrounding traffic by utilizing the distances measured by distance measuring device 105 and current vehicle speed. A warning output device 115 can be utilized for outputting an alarm to a driver when the distance calculated by the distance measuring device 105 is less than the safe distance calculated by the processor 110.

FIG. 2 illustrates a perspective view of vehicle 200 showing a steering 210, a dashboard 205, and the display 120 of safe distance measuring device 100 depicted in FIG. 1, in accordance with the disclosed embodiments. The display 120 shows the surrounding traffic and the safe distance between the vehicle 200 and the surrounding traffic. A display 120, for example, an instrument cluster can be installed for displaying the safe distances to the driver. The display 120 can be in any convenient visible part inside the vehicle 200 so the driver can keep a safe distance from the surrounding traffic.

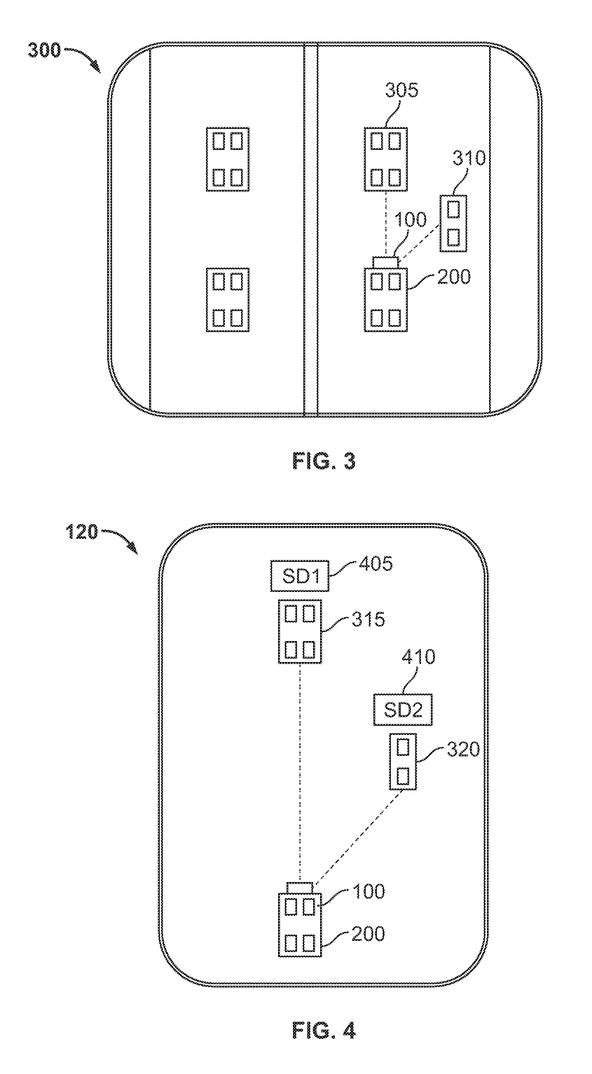

FIG. 3 illustrates a top view of road traffic 300 showing the vehicle 200 installed with the safe distance measuring device 100 depicted FIG. 1, in accordance with the disclosed embodiments. The safe distance measuring device 100 installed in the vehicle 200 measures the distance between the vehicle 200 and surrounding vehicles such as vehicles (305 and 310). The distance between the vehicle 200 and the surrounding vehicles (305 and 310) can be utilized for calculating the safe distance to be maintained by the driver for each surrounding vehicles (305 and 310).

FIG. 4 illustrates a perspective view of a display 120 demonstrating the safe distance measuring device 100 depicted in FIG. 1, in accordance with the disclosed embodiments. The distance SD1 405 is the safe distance between the vehicle 200 and surrounding vehicle 315. Similarly, the distance SD2 410 is the safe distance between the vehicle 200 and surrounding vehicle 320. Along with the vehicle 200 and the surrounding vehicles (315 and 320), the safe distance such as SDI 405 and SD2 410 are shown on the display. The driver can maintain the safe distances SD1 405 and SD2 410 by looking at the display.

FIG. 5 illustrates a high level flow chart of a method 500 for measuring and displaying the safe distance between a vehicle and surrounding traffic, in accordance with disclosed embodiments. As indicated at block 505, the process begins. Note that the steps depicted in FIG. 5 can be implemented in some embodiments as soon as the driver starts the vehicle. As illustrated at block 510, the vehicle speed can be measured via a speed sensor such as, for example, the speed sensor 125 discussed herein.

Next, as indicated at block 515, a distance-measuring device such as, for example, the distance-measuring device 105 can automatically calculate the distance between the vehicle and the surrounding traffic. As depicted next at block 520, the safe distance between the vehicle and surrounding traffic can be calculated by utilizing a measured distance between the vehicle and surrounding traffic and vehicle speed information. The calculated safe distance can then be displayed to the driver and/or passengers of the vehicle by utilizing, for example, an instrument cluster or instrument panel, as illustrated at block 525. An example of such an instrument panel or cluster is depicted in FIG. 2 (e.g., a dashboard display).

Following the process of the operation depicted at block 525, a test can be performed as indicated at block 527 to determine if the safe distance is in fact ‘safe’. If the distance between the vehicle and a nearby vehicle is safe, then green numbers can be displayed for the driver/user, as indicated at block 529. If not, then red numbers can be displayed as indicated at block 530, followed by an audible or visual alarm as indicated at block 531. Following the process of these operations, a test can be performed, as indicated at block 535, to determine if the vehicle is stopped. If the answer is “Yes”, then the process can then terminate, as indicated at block 540. If the answer is “No”, then the operations illustrated at block 510, 515, and so forth can be repeated until the vehicle actually comes to a stop. In this manner, the “safe distance” between the vehicle and surrounding is constantly being monitored.

The driver is thus provided with a warning when the distance between the vehicle and other vehicles in surrounding traffic is less than the safe distance, and a “safe distance” can be displayed by, for example, green numbers and an unsafe distance can be displayed by red numbers, followed by a warning sound if vehicles are following too close to the driver's vehicles or vice versa.

It can be appreciated based on the foregoing that a safe distance measuring apparatus for a vehicle is disclosed, which includes in at least one embodiment at least one distance-measuring device for measuring a plurality of distances from the vehicle to at least one of a plurality of other vehicles, and a speed sensor for sensing a current speed of the vehicle. Such an embodiment can also include a display unit for displaying a plurality of safe distances, and a warning output device for outputting an alarm to a driver of the vehicle when at least one of the plurality of distances is less than the corresponding calculated plurality of safe distances.

In another embodiment, a processor can be employed for calculating the plurality of safe distances from the vehicle to the plurality of vehicles by utilizing the plurality of distances and the current speed. In general, the safe distance measuring device can be installable within the vehicle. In some embodiments, the distance-measuring device can be a LASER type device. In yet other embodiments, the distance-measuring device may be a RADAR type device. In still other embodiments, the distance-measuring device can be an image capturing distance measuring type device or another appropriate device. Additionally, in some embodiments, the display unit displays graphical data indicative of traffic surrounding the vehicle and data indicative of a safe distance between the vehicle and the traffic surrounding the vehicle.

It can also be appreciated based on the foregoing that in accordance with another embodiment, a safe distance measuring apparatus for a vehicle can be implemented, which includes at least one distance-measuring device for measuring a plurality of distances from the vehicle to at least one of a plurality of other vehicles; a speed sensor for sensing a current speed of the vehicle; a processor for calculating a plurality of safe distances from the vehicle to the plurality of vehicles by utilizing the plurality of distances and the current speed; a display unit for displaying the plurality of safe distances; and a warning output device for outputting an alarm to a driver of the vehicle when at least one of the plurality of distances is less than the corresponding calculated plurality of safe distances.

In such an embodiment, the safe distance measuring device can be installable within the vehicle. In variations to such an embodiment, the aforementioned distance-measuring device can be, for example, a LASER type device, a RADAR type device, and/or an image capturing distance measuring type device, and so forth. Additionally, in such an embodiment, the display unit can display graphical data indicative of traffic surrounding the vehicle and data indicative of a safe distance between the vehicle and the traffic surrounding the vehicle.

It can also be appreciated based on the foregoing description that various methods can be implemented for providing safe distance measurement data for a vehicle. One example of such a method can include the steps of measuring a plurality of distances from the vehicle to at least one of a plurality of other vehicles utilizing at least one-distance-measuring device; sensing a current speed of the vehicle utilizing a speed sensor; automatically calculating a plurality of safe distances from the vehicle to the plurality of vehicles by utilizing the plurality of distances and the current speed; displaying the plurality of safe distances via a display unit; and generating an alarm to a driver of the vehicle when at least one of the plurality of distances is less than the corresponding calculated plurality of safe distances.

In a variation to such an embodiment, the safe distance measuring device can be installable within the vehicle. Additionally, in alternative embodiment of such a method, the distance-measuring device can be, for example, a LASER type device, a RADAR type device, an image capturing distance measuring type device, and so forth. The display unit in such a method can be configured and instructed to display graphical data indicative of traffic surrounding the vehicle and data indicative of a safe distance between the vehicle and the traffic surrounding the vehicle.

It can be further appreciated based on the foregoing that in another embodiment, a processor-readable medium storing code representing instructions to cause a processor to perform a process can be implemented, wherein the code comprises code to, for example, measure a plurality of distances from the vehicle to at least one of a plurality of other vehicles utilizing at least one-distance-measuring device; detect a current speed of the vehicle utilizing a speed sensor; automatically calculate a plurality of safe distances from the vehicle to the plurality of vehicles by utilizing the plurality of distances and the current speed; display the plurality of safe distances via a display unit; and generate an alarm to a driver of the vehicle when at least one of the plurality of distances is less than the corresponding calculated plurality of safe distances.

In an alternative embodiment, the processor-readable medium can be configured such that the safe distance measuring device is installable within the vehicle. Additionally, in the context of such a processor-readable medium and variations to embodiments thereof, the distance-measuring device can be, for example, a LASER type device, a RADAR type device, an image capturing distance measuring type device, and so forth. The display unit can receive instructions via the processor-readable medium to display graphical data indicative of traffic surrounding the vehicle and data indicative of a safe distance between the vehicle and the traffic surrounding the vehicle.

It will be appreciated that variations of the above disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A safe distance measuring apparatus for a vehicle, said apparatus comprising:
at least one distance-measuring device for measuring a plurality of distances from said vehicle to at least one of a plurality of other vehicles;
a speed sensor for sensing a current speed of said vehicle;
a display unit for displaying a plurality of safe distances; and
a warning output device for outputting an alarm to a driver of said vehicle when at least one of said plurality of distances is less than the corresponding calculated said plurality of safe distances.

2. The apparatus of claim 1 further comprising a processor for calculating said plurality of safe distances from said vehicle to said plurality of vehicles by utilizing said plurality of distances and said current speed.

3. The apparatus of claim 1 wherein said safe distance measuring device is installable within said vehicle.

4. The apparatus of claim 1 wherein said at least one distance-measuring device comprises a LASER type device.

5. The apparatus of claim 1 wherein said at least one distance-measuring device comprises a RADAR type device.

6. The apparatus of claim 1 wherein said at least one distance-measuring device comprises an image capturing distance measuring type device.

7. The apparatus of claim 3 wherein said display unit displays graphical data indicative of traffic surrounding said vehicle and data indicative of a safe distance between said vehicle and said traffic surrounding said vehicle.

8. A safe distance measuring apparatus for a vehicle, said apparatus comprising:
at least one distance-measuring device for measuring a plurality of distances from said vehicle to at least one of a plurality of other vehicles;
a speed sensor for sensing a current speed of said vehicle;
a processor for calculating a plurality of safe distances from said vehicle to said plurality of vehicles by utilizing said plurality of distances and said current speed;
a display unit for displaying said plurality of safe distances; and
a warning output device for outputting an alarm to a driver of said vehicle when at least one of said plurality of distances is less than the corresponding calculated said plurality of safe distances.

9. The apparatus of claim 8 wherein said safe distance measuring device is installable within said vehicle.

10. The apparatus of claim 8 wherein said at least one distance-measuring device comprises a LASER type device.

11. The apparatus of claim 8 wherein said at least one distance-measuring device comprises a RADAR type device.

12. The apparatus of claim 8 wherein said at least one distance-measuring device comprises an image capturing distance measuring type device.

13. The apparatus of claim 9 wherein said display unit displays graphical data indicative of traffic surrounding said vehicle and data indicative of a safe distance between said vehicle and said traffic surrounding said vehicle,

14. A method for providing safe distance measurement data for a vehicle, said method comprising:
measuring a plurality of distances from said vehicle to at least one of a plurality of other vehicles utilizing at least one-distance-measuring device;
sensing a current speed of said vehicle utilizing a speed sensor;
automatically calculating a plurality of safe distances from said vehicle to said plurality of vehicles by utilizing said plurality of distances and said current speed;
displaying said plurality of safe distances via a display unit; and
generating an alarm to a driver of said vehicle when at least one of said plurality of distances is less than the corresponding calculated said plurality of safe distances.

15. The apparatus of claim 14 wherein said safe distance measuring device is installable within said vehicle.

16. The apparatus of claim 14 wherein said at least one distance-measuring device comprises a LASER type device.

17. The apparatus of claim 14 wherein said at least one distance-measuring device comprises a RADAR type device.

18. The apparatus of claim 14 wherein said at least one distance-measuring device comprises an image capturing distance measuring type device.

19. The apparatus of claim 15 wherein said display unit displays graphical data indicative of traffic surrounding said vehicle and data indicative of a safe distance between said vehicle and said traffic surrounding said vehicle,

20. A processor-readable medium storing code representing instructions to cause a processor to perform a process, the code comprising code to:
measure a plurality of distances from said vehicle to at least one of a plurality of other vehicles utilizing at least one-distance-measuring device;
detect a current speed of said vehicle utilizing a speed sensor;
automatically calculate a plurality of safe distances from said vehicle to said plurality of vehicles by utilizing said plurality of distances and said current speed;
display said plurality of safe distances via a display unit; and
generate an alarm to a driver of said vehicle when at least one of said plurality of distances is less than the corresponding calculated said plurality of safe distances.

21. The processor-readable medium of claim 20 wherein said safe distance measuring device is installable within said vehicle.

22. The processor-readable medium of claim 20 wherein said at least one distance-measuring device comprises a LASER type device.

23. The processor-readable medium of claim 20 wherein said at least one distance-measuring device comprises a RADAR type device.

24. The processor-readable medium of claim 20 wherein said at least one distance-measuring device comprises an image capturing distance measuring type device.

25. The processor-readable medium of claim 21 wherein said display unit displays graphical data indicative of traffic surrounding said vehicle and data indicative of a safe distance between said vehicle and said traffic surrounding said vehicle.
